(19) United States
(12) Patent Application Publication
(10) Pub. No.: US 2013/0045385 A1
(43) Pub. Date: Feb. 21, 2013

(54) METAL POWDER, METHOD FOR PREPARING THE SAME, AND MULTILAYERED CERAMIC CAPACITOR INCLUDING INNER ELECTRODE MADE OF METAL POWDER

(71) Applicants: Woon Chun KIM, Gyeonggi-do (KR); Hyun Ho Lim, Gyeonggi-do (KR); Sung Kwon Wi, Seoul (KR); Kyu Sang Lee, Gyeonggi-do (KR)

(72) Inventors: Woon Chun KIM, Gyeonggi-do (KR); Hyun Ho Lim, Gyeonggi-do (KR); Sung Kwon Wi, Seoul (KR); Kyu Sang Lee, Gyeonggi-do (KR)

(73) Assignee: Samsung Electro-Mechanics Co., Ltd., Suwon (KR)

(21) Appl. No.: 13/548,949

(22) Filed: Jul. 13, 2012

(30) Foreign Application Priority Data
Aug. 16, 2011 (KR) 10-2011-0081198

(51) Int. Cl. B32B 5/16; B01J 19/08; B05D 7/14

(52) U.S. Cl. 428/403; 427/79; 427/560

(57) ABSTRACT

A metal powder including a graphene layer irregularly formed on a surface of the metal powder, a method for preparing the same, and a multilayered ceramic capacitor including an inner electrode using the metal powder. By using the metal powder having the graphene irregularly formed on the surface thereof as the inner electrode material of the multilayered ceramic capacitor, and allowing the necking phenomenon to occur on only the surface where the graphene is not formed, the necking of the metal powder is delayed and the shrinkage of the inner electrode is controlled, so that reduction of the thickness of the inner electrode and disconnection/crack can be prevented.

### CROSS REFERENCE(S) TO RELATED APPLICATIONS

This application claims the benefit under 35 U.S.C. Section 119 of Korean Patent Application Serial No. 10-2011-0081198, entitled “Metal Powder, Method for Preparing the Same, and Multilayered Ceramic Capacitor Including Inner Electrode of Metal Powder” filed on Aug. 16, 2011, which is hereby incorporated by reference in its entirety into this application.

### BACKGROUND OF THE INVENTION

1. Technical Field

The present invention relates to a metal powder, a method for preparing the same, and a multilayered ceramic capacitor including an inner electrode made of the metal powder.

2. Description of the Related Art

A multilayered ceramic capacitor (MLCC) includes an inner electrode in a dielectric ceramic and manufactures the inner electrode by firing it about 900° C.

As an inner electrode material, a nickel (Ni) powder is most commonly used and, as a powder for the dielectric ceramic, BaTiO₃ is mainly used. If the dielectric ceramic including the inner electrode is fired simultaneously, a necking phenomenon in which nickel metal becomes condensed with one another occurs due to a shrinkage difference between the nickel metal of the inner electrode and the BaTiO₃ powder of the dielectric ceramic. Accordingly, mismatch between the inner electrode and the dielectric layer causes crack in the inner electrode or causes a defect such as delamination.

FIG. 1 is a view illustrating a part of a cross section of a multilayered ceramic capacitor (MLCC) structure including an inner electrode in a dielectric ceramic.

Referring to FIG. 1, the MLCC structure includes a dielectric layer 10 consisting of a dielectric ceramic powder 11 and an inner electrode 20 multi-layered on the dielectric layer 10. However, if the dielectric ceramic including the inner electrode 20 is fired simultaneously, disconnection (A) occurs between the inner electrodes due to the shrinkage difference and thus there is a problem in that smoothness and connectivity of the inner electrode deteriorate.

Also, since the inner electrode 20 permeates (B) through the dielectric layer 10, reliability of the dielectric layer 10 may deteriorate or a breakdown voltage (BDV) may be lowered.

Accordingly, as a method to solve the above problems, a technique of mixing a ceramic powder which is the same as that of the dielectric layer with a nickel powder of the inner electrode as a common material has been suggested in order to reduce the shrinkage of the inner electrode.

FIG. 2 illustrates an effect occurring if the dielectric ceramic powder is mixed with the nickel inner electrode as the common material. Referring to FIG. 2, nickel powder 21 forming the inner electrode causes a necking phenomenon at a low temperature and exhibits a condensed structure therebetween. If the necking phenomenon is caused too much between the nickel powder particles, there is a problem in that sintering rapidly advances, thus a necking phenomenon should be prevented.

In this state, if dielectric ceramic powder common materials 11 are added in order to reduce the shrinkage of the inner electrode, the dielectric ceramic powder common materials 11 are positioned on contact points where the nickel powder particles 21 contact and thus prevent the necking phenomenon of the nickel powder and delays the sintering. Also, the added dielectric ceramic powder common materials 11 use a principle in which the dielectric ceramic powder common materials are separated from the nickel inner electrode and join the dielectric layer.

However, this method reaches the limit in its effect as the firing temperature increases, and, since it is difficult to control the shrinkage difference up to a desired level, this method is insufficient to effectively control the shrinkage difference between the nickel powder used as the inner electrode and the dielectric ceramic powder forming the dielectric layer.

### SUMMARY OF THE INVENTION

The present invention has been developed in order to solve the above related art problems that are caused by a shrinkage difference between the materials used as an inner electrode and a dielectric layer of a multilayered ceramic capacitor, and an object of the present invention is to provide a metal powder which has a structure similar to a dielectric layer in its shrinkage characteristic.

Also, another object of the present invention is to provide a method for preparing the metal powder.

Also, still another object of the present invention is to provide a multilayered ceramic capacitor including the metal powder as an inner electrode.

According to an exemplary embodiment of the present invention, there is provided a metal powder including a graphene layer which is irregularly formed on a surface of the metal powder.

A metal surface which includes the graphene layer irregularly formed and a metal surface which does not include the graphene layer may have different sintering characteristics.

The metal powder may have one or more shapes selected from the group consisting of a spherical shape, a rectangular shape, a polyhedral shape, and a cylindrical shape, but is not limited thereto.

The metal powder may be one or more materials selected from the group consisting of Ni, Cu, Co, Fe, Pt, Au, Al, Cr, Mg, Mn, Mo, Rh, Si, Ta, Ti, W, U, V, and Zr.

The metal powder may be used as an inner electrode of a multilayered ceramic capacitor, but is not limited thereto.

According to another exemplary embodiment of the present invention, there is provided a method for preparing a metal powder, the method including: a first step of multi-layering metal powders; a second step of injecting a carbon supply source to the multilayered metal powders and coating a surface of the multilayered metal powders with the carbon supply source; a third step of performing heat treatment on the metal powders coated with the carbon supply source and forming graphene on the surface of the metal powders; and a fourth step of separating the metal powders from one another.

Each of the first through the third steps may be performed in a state where agitation is not applied.

In the heat treatment of the third step, the graphene may be irregularly formed on only the surface of the metal powder that is coated with the carbon supply source.

The multilayered metal powders may be separated from one another at the fourth step separating the metal powders.

The metal powders may be separated by one selected from a cutter, an ultrasonic processor, a mill, a fluidizer, and a nanomizer, but is not limited thereto.

According to still another exemplary embodiment of the present invention, there is provided an inner electrode of a multilayered ceramic capacitor including a metal powder which includes a graphene layer irregularly formed on a surface of the metal powder.

The inner electrode of the multilayered ceramic capacitor may further include one or more selected from a metal powder which does not include the graphene layer and a dielectric ceramic powder.

The metal powder may be one or more materials selected from the group consisting of Ni, Cu, Co, Fe, Pt, Au, Al, Cr, Mg, Mn, Mo, Rh, Si, Ta, Ti, W, U, V, and Zr, but is not limited thereto.

According to still another exemplary embodiment of the present invention, there is provided a multilayered ceramic capacitor including the inner electrode.

### BRIEF DESCRIPTION OF THE DRAWINGS

FIG. 1 is a view illustrating a part of a cross section of a multilayered ceramic capacitor (MLCC) structure including an inner electrode in a dielectric ceramic;

FIG. 2 is a view illustrating an effect occurring when a dielectric ceramic powder is mixed with a nickel inner electrode as a common material;

FIG. 3 is a view illustrating a cross section and a surface shape of a metal powder according to an exemplary embodiment of the present invention;

FIG. 4 is a view illustrating a process of preparing a metal powder according to an exemplary embodiment the present invention; and

FIG. 5 is a view illustrating a necking phenomenon of metal powder in which graphene is irregularly formed on a surface of the metal powder prepared according to an exemplary embodiment of the present invention.

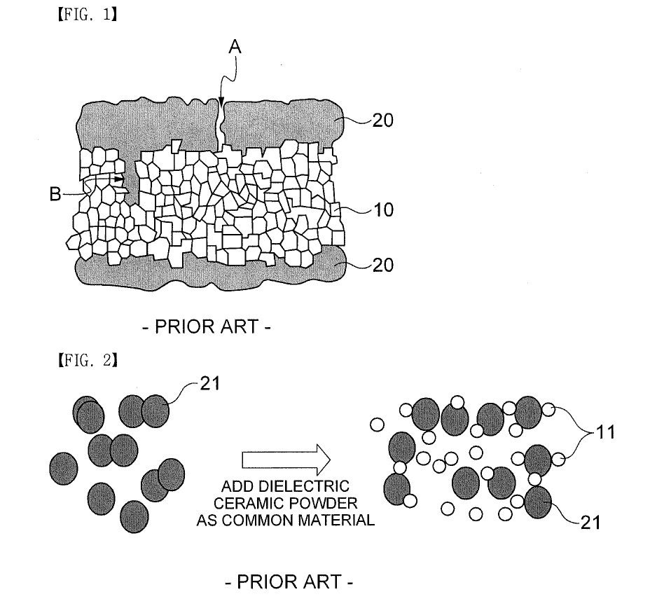

### DESCRIPTION OF THE PREFERRED EMBODIMENTS

Hereinafter, exemplary embodiments will be described in greater detail with reference to the accompanying drawings.

The terms used in the present specification and claims should not be interpreted as being limited to typical meanings or dictionary definitions. In the following description, the singular expression is intended to include the plural expression unless the context clearly indicates otherwise. The terms ‘comprises’ and/or ‘comprising’ used in the specification and claims specifically define the presence of mentioned shapes, figures, steps, operations, elements, components, and/or groups and do not preclude the presence or addition of one or more other shapes, figures, operations, elements, components, and/or groups.

The present invention relates to a metal powder for an inner electrode, a method for preparing the same, an inner electrode including the metal powder, and a multilayered ceramic capacitor including the same.

1. Metal Powder for Inner Electrode

A metal powder according to the present invention is used as a main material of an inner electrode and has a structure in which graphene is irregularly formed on a surface of the metal powder in order to minimize a shrinkage difference between the metal powder and a dielectric ceramic material forming a dielectric layer.

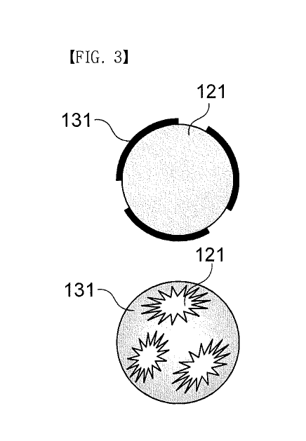

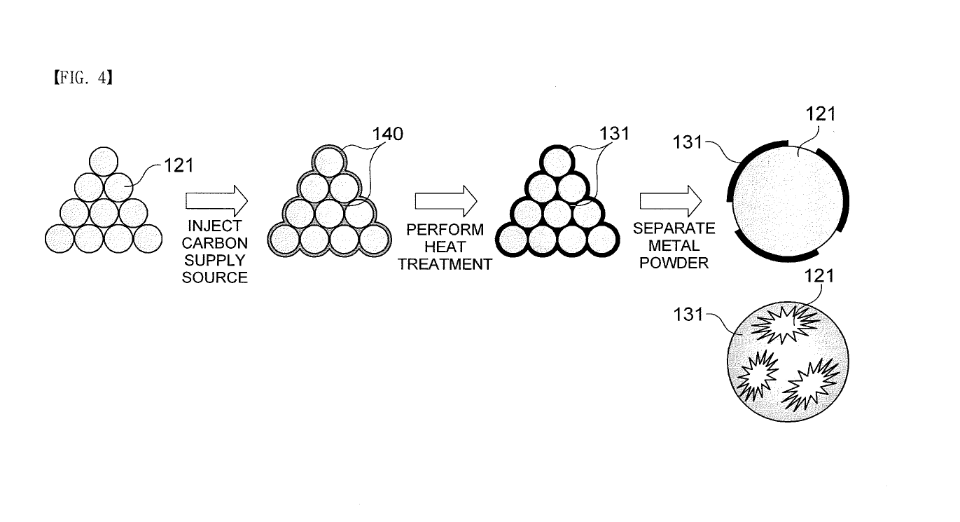

FIG. 3 illustrates a cross section (top) and a surface shape (bottom) of a metal powder according to the present invention. Referring to FIG. 3, the present invention includes a graphene layer 131 irregularly formed on a surface of a metal powder 121.

Accordingly, it can be expected that a metal surface which includes the graphene layer 131 irregularly formed and a metal surface which does not include the graphene layer 131 have different shrinkage characteristics. As a result, since each of the metal powder has different shrinkage characteristics, its sintering characteristic may also be different.

Accordingly, if the above metal powder is used as an inner electrode material of the multilayered ceramic capacitor, a sintering characteristic is improved by improving the shrinkage difference between the metal powder and the dielectric ceramic powder.

The metal powder may be one or more material selected from the group consisting of Ni, Cu, Co, Fe, Pt, Au, Al, Cr, Mg, Mn, Mo, Rh, Si, Ta, Ti, W, U, V, and Zr.

A thickness of the graphene layer irregularly formed on the surface of the metal powder may be 1 μg or less and more preferably may be several nm. The thickness of the graphene layer may be adjusted by changing a content of a carbon supply source and a heat treatment condition.

The “graphene layer” recited in the present invention has a bonding structure similar to a graphene sheet in which carbon is connected in a hexagonal plate-shaped structure, and may have a spherical shape, a cylindrical shape, or a polyhedral shape in which graphene is bent while maintaining an appropriate bonding angle.

Therefore, the metal powder according to the present invention may have, but not limited to, one or more shapes selected from the group consisting of a spherical shape, a rectangular shape, a polyhedral shape, and a cylindrical shape.

A metal powder finally prepared may be determined according the shape of the inner metal powder. Accordingly, according to the shape of the final metal powder, the shape of the inner metal powder may be selected and prepared.

2. Method for Preparing Metal Powder for Inner Electrode

A method for preparing a metal powder for an inner electrode according to the present invention includes a first step of multi-layering metal powders, a second step of injecting a carbon supply source into the multilayered metal powders and coating a surface of the multilayered metal powders with the carbon supply source, a third step of performing heat treatment on the metal powders coated with the carbon supply source and forming graphene on the surface of the metal powder, and a fourth step of separating the metal powders.

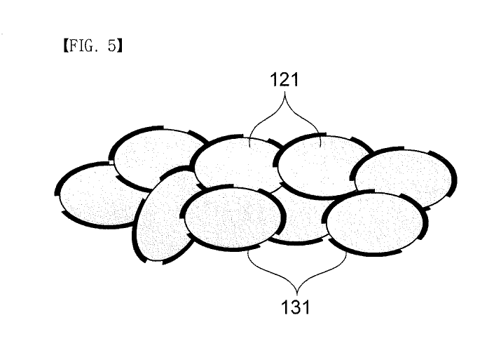

FIG. 4 illustrates a process of preparing the metal powder. The method for preparing the metal powder will be explained with reference to FIG. 4.

At first step, metal powders 121 are multilayered. The metal powders 121 may be multi-layered regularly due to a characteristic of metal. It is important not to apply agitation or any external condition to the metal powders 121. In other words, it is preferable that the metal powders 121 are maintained in a multilayered state.

At second step, a carbon supply source 140 is injected into the multilayered metal powders 121 and is coated over the surface of the multilayered metal powders 121. If the carbon supply source 140 is injected as shown in FIG. 4, an empty space between the multilayered metal powders 121 or an outermost surface is coated with the carbon supply source 140.

The injected carbon supply source 140 is not limited to a specific material and any material that can form graphene by a subsequent process, that is, a heat treatment process, can be used. For example, the carbon supply source 140 may be, but not limited to, a carbonous polymer such as an amphiphilic polymer, a liquid crystal polymer, and a conductive polymer; a liquid carbon material such as an alcohol organic solvent; and a gaseous carbon material such as methane, ethane, and acetylene.

At second step, neither agitation nor an external condition is applied to the metal powders 121. This is to coat only a selective area contacting the injected carbon supply source with the carbon supply source.

At third step, graphene 131 is formed on the surface of the metal powders by performing heat treatment on the metal powder 121 coated with the carbon supply source 140. The heat treatment may be performed for 0.1˜10 hours in an inert atmosphere of 400˜1500° C. or in a reduction atmosphere.

The heat treatment may be performed by, but not limited to, one or more methods selected from the group consisting of induction heating, radiant heating, laser heating, IR heating, microwave heating, plasma heating, UV heating, and surface Plasmon heating.

By such heat treatment, all components of the carbon supply source except for the carbon component are volatilized and only the carbon components are bonded to each other, thereby forming cubic graphene.

Finally, at fourth step, the metal powders are separated from one another.

The metal powders are separated by, but not limited to, a cutter, an ultrasonic processor, a mill, a fluidizer, and a nanomizer.

The multilayered metal powders 121 are separated from one another at fourth step of separating the metal powders.

Through the above-described process, the graphene 131 is irregularly formed on only a part of the surface of the metal powder 121 as shown in FIG. 4. Therefore, the surface of the metal powder 121 on which the graphene 131 is formed and the surface of the metal powder 121 on which the graphene 131 is not formed have different shrinkage characteristics.

Accordingly, by making a necking phenomenon occur in the metal powder 121 on which the graphene 131 is formed and then making a necking phenomenon occur on only the surface of the metal powder 121 on which the graphene 131 is not formed as shown in FIG. 5, the necking of the metal powder 121 is delayed and the shrinkage of the inner electrode is controlled, so that reduction of the thickness of the inner electrode can be prevented and disconnection/crack can be minimized.

3. Multilayered Ceramic Capacitor

A multilayered ceramic capacitor of the present invention may include an inner electrode which uses a metal powder including a graphene layer irregularly formed on a surface of the metal powder.

Also, the inner electrode may further include a pure metal powder or a dielectric ceramic powder which is used as a general inner electrode material.

The metal powder may be, but not limited to, one or more material selected from the group consisting of Ni, Cu, Co, Fe, Pt, Au, Al, Cr, Mg, Mn, Mo, Rh, Si, Ta, Ti, W, U, V, and Zr.

Also, the dielectric ceramic powder may use the same as that of a dielectric ceramic material used as a body material.

The body material and an external electrode used in the multilayered ceramic capacitor of the present invention use general materials and are not limited to a specific material and a specific preparing method.

According to the present invention, by using the metal powder having the graphene irregularly formed on the surface thereof as the inner electrode material of the multilayered ceramic capacitor, and allowing the necking phenomenon to occur on only the surface where the graphene is not formed, the necking of the metal powder is delayed and the shrinkage of the inner electrode is controlled, so that reduction of the thickness of the inner electrode and disconnection/crack can be prevented.

While the present invention has been shown and described in connection with the embodiments, it will be apparent to those skilled in the art that modifications and variations can be made without departing from the spirit and scope of the invention as defined by the appended claims.

1. A metal powder comprising a graphene layer which is irregularly formed on a surface of the metal powder.

2. The metal powder according to claim 1, wherein a metal surface which includes the graphene layer irregularly formed and a metal surface which does not include the graphene layer have different sintering characteristics.

3. The metal powder according to claim 1, wherein the metal powder has one or more shapes selected from the group consisting of a spherical shape, a rectangular shape, a polyhedral shape, and a cylindrical shape.

4. The metal powder according to claim 1, wherein the metal powder is one or more materials selected from the group consisting of Ni, Cu, Co, Fe, Pt, Au, Al, Cr, Mg, Mn, Mo, Rh, Si, Ta, Ti, W, U, V, and Zr.

5. The metal powder according to claim 1, wherein the metal powder is used as an inner electrode of a multilayered ceramic capacitor.

6. A method for preparing a metal powder, the method comprising:
multi-layering metal powders;
injecting a carbon supply source to the multilayered metal powders and coating a surface of the multilayered metal powders with the carbon supply source;
performing a heat treatment on the metal powders coated with the carbon supply source and forming graphene on the surface of the metal powders; and
separating the metal powders from one another.

7. The method according to claim 6, wherein each of the multilayering metal powders, the injecting a carbon supply source, and the performing a heat treatment is performed in a state where agitation is not applied.

8. The method according to claim 6, wherein, in the performing the heat treatment, the graphene is irregularly formed on only the surface of the metal powder that is coated with the carbon supply source.

9. The method according to claim 6, wherein the multilayered metal powders are separated from one another through the separating the metal powders.

10. The method according to claim 6, wherein the metal powders are separated by one selected from a cutter, an ultrasonic processor, a mill, a fluidizer, and a nanomizer.

11. An inner electrode of a multilayered ceramic capacitor including a metal powder which includes a graphene layer irregularly formed on a surface of the metal powder.

12. The inner electrode of the multilayered ceramic capacitor according to claim 11, further comprising one or more selected from a metal powder which does not include the graphene layer and a dielectric ceramic powder.

13. The inner electrode of the multilayered ceramic capacitor according to claim 12, wherein the metal powder is one or more materials selected from the group consisting of Ni, Cu, Co, Fe, Pt, Au, Al, Cr, Mg, Mn, Mo, Rh, Si, Ta, Ti, W, U, V, and Zr.

14. A multilayered ceramic capacitor including the inner electrode according to claim 11.
